(19) United States
(12) Patent Application Publication
(10) Pub. No.: US 2014/0065453 A1
(43) Pub. Date: Mar. 6, 2014

(54) ELECTROCHEMICAL ENERGY STORAGE CELL AND ELECTROCHEMICAL ENERGY STORAGE DEVICE COMPRISING AT LEAST ONE SUCH ELECTROCHEMICAL ENERGY STORAGE CELL

(71) Applicants: Li-Tec Battery GmbH, Kamenz (DE); Daimler AG, Stuttgart (DE)

(72) Inventors: Tim Schaefer, Harztor (DE); Detlef Dieball, Dresden (DE)

(73) Assignees: Daimler AG, Stuttgart (DE); Li-Tec Battery GmbH, Kamenz (DE)

(21) Appl. No.: 14/011,365

(22) Filed: Aug. 27, 2013

Related U.S. Application Data
(60) Provisional application No. 61/694,810, filed on Aug. 30, 2012.
(60) Provisional application No. 61/694,821, filed on Aug. 30, 2012.

(30) Foreign Application Priority Data
Aug. 30, 2012 (DE) 10 2012 017 184.6
Aug. 30, 2012 (DE) 10 2012 017 190.0

(51) Int. Cl. H01M 2/34; H01M 10/48; H01M 2/02

(52) U.S. Cl. CPC H01M 2/347; H01M 2/0287; H01M 10/48
USPC 429/61; 429/163; 429/90

(57) ABSTRACT

An electrochemical energy storage cell (10) includes an electrode assembly (12), which comprises at least one first electrode (14) of a first polarity and at least one second electrode (16) of a second polarity, and a film-like casing (24), which at least partially encloses the electrode assembly (12). To improve safety, the casing (24) comprises at least one first functional layer (243), which is designed to be at least partially electrically conductive and is connected to the at least one first electrode (14) of the electrode assembly (12) in an electrically conductive manner (21), and at least one electrical insulating layer (245), which separates the first functional layer (243) of the casing (24) in a layering direction (25) of the casing from the electrode assembly (12) in the normal operating state of the energy storage cell (10).

### DESCRIPTION

The present invention relates to an electrochemical energy storage cell, particularly in the form of a pouch or coffee bag cell, and an electrochemical energy storage device or battery comprising at least one such electrochemical energy storage cell.

The invention is described by way of example in connection with lithium ion batteries for the supply of motor vehicle drives. Reference is made to the fact that the invention can also be used independently of the battery design, the chemistry of the electrochemical energy storage cell and independently of the nature of the drive being supplied.

Batteries with a plurality of electrochemical energy storage cells for the supply of motor vehicle drives are known from the state of the art. Electrochemical energy storage cells are normally electrically connected to one another, particularly in order to increase the battery voltage, the battery output and/or the range of the motor vehicle supplied by the battery.

Customary energy storage cells comprise an electrode assembly with at least two electrodes of different polarity and a separator. The separator separates or spaces apart the electrodes of different polarity. Furthermore, customary energy storage cells comprise a cell casing, which at least partially encloses the electrode assembly. In the case of so-called pouch or coffee bag cells, this cell casing has a film-like design and generally a multi-layered structure.

Particularly when used in motor vehicles, but not only there, the aspect of such batteries or energy storage cells which is particularly important is safety. Safety must also be guaranteed in the case of mechanical loads from outside, such as the impact of foreign bodies such as nails and the like. Apart from the approach of preventing the penetration of foreign bodies by means of high-strength battery housings, for example, a further approach to solving the problem involves a battery or energy storage cell being at least partially discharged in a controlled manner during (partially) penetration of a foreign body, in order to reduce the risk to vehicle passengers and rescue workers, for example. Protective measures of this kind become even more important as battery capacities and energy densities increase.

It is the object of the invention to provide batteries or energy storage cells which offer greater safety.

This object is achieved by an electrochemical energy storage cell having the features of claim 1. Particularly preferred configurations and further developments of the invention are subject-matter of the dependent claims.

The electrochemical energy storage cell according to the invention comprises an electrode assembly comprising a first electrode of a first polarity and at least one second electrode of a second polarity, and a film-like casing, which at least partially encloses the electrode assembly. The casing comprises at least one first functional layer, which is designed to be at least partially electrically conductive and is connected in an electrically conductive manner to the at least one first electrode of the electrode assembly, and at least one electrical insulating layer, which separates the first functional layer from the electrode assembly in a layering direction of the casing in the normal operating state of the energy storage cell.

If a foreign body acts on or encounters a battery according to the invention, particularly an electrochemical energy storage cell of the battery according to the invention, for example during an accident, particularly one involving a motor vehicle, the energy storage cell may be damaged. It has been observed that a conventional battery releases energy into the environment in an uncontrolled manner, particularly following damage particularly to one of its energy storage cells. The energy storage cell according to the invention offers the advantage that in the event of a foreign body penetrating the casing or pressure being applied to the casing from outside, the first functional layer of the casing of the energy storage cell can create a closed current path between the electrodes of different polarity in the energy storage cell. The energy storage cell is then able to discharge in a controlled fashion via this closed current path. The casing with the at least one first functional layer can therefore be referred to as a “nail safety device”.

While the first functional layer of the casing is separated from the components of the energy storage cell of second polarity in the normal operating state of the energy storage cell, this insulation is either bridged by the foreign body itself during penetration by the foreign body, if this is an electrically conductive foreign body such as a metal nail, for example, or removed by deformation of the casing and direct contact between the first functional layer and the corresponding other components. The afore-mentioned mechanism also comes into play when there is a particularly locally limited, particularly substantially point-based pressure application on the casing from outside.

The first functional layer is a constituent part of the film-like casing, so that a particularly simple configuration of the electrochemical energy storage cell according to the invention with a small number of components results. In this case, the first functional layer is preferably integrated in the casing of the energy storage cell or is a constituent part of a combined multi-layered structure or is inserted as a separate structural unit. Through this incorporation of the protective mechanism into the casing of the energy storage cell, the desired increase in safety can be achieved with the energy storage cells according to the invention, irrespective of the structure of the battery having these energy storage cells.

An electrochemical energy storage cell within the meaning of the invention is understood to be a device which is particularly used to convert chemical energy into electrical energy at least temporarily and to make electrical energy available particularly to a consumer at least temporarily. An electrochemical energy storage device must be distinguished from an energy storage cell in this context, said energy storage device accommodating one or preferably a plurality of such energy storage cells in a housing. An energy storage device of this kind is also referred to as a battery within the meaning of the invention.

The electrochemical energy storage cell comprises an electrode assembly. An electrode assembly within the meaning of the invention should be taken to mean a device which is particularly used to provide electrical energy. The electrode assembly is preferably configured to convert in particular stored chemical energy into electrical energy, before the electrode assembly supplies this electrical energy to a consumer. The electrode assembly is preferably also designed to convert supplied electrical energy into chemical energy and to store it as chemical energy. This is then referred to as a rechargeable electrode assembly.

The electrode assembly comprises at least two electrodes of different polarity (first and second electrodes within the meaning of the invention). The electrodes of the electrode assembly preferably each have a particularly metallic collector film, as well as one or two active masses. The active mass is applied to at least one side of the collector film. Two active masses of different polarity are arranged on different surfaces of the collector film and spaced apart by the collector film. During the charging or discharging of the electrode assembly, electrons are exchanged between the collector film and the active mass(es). The collector film preferably comprises the materials copper and/or aluminium. One or a plurality of conductor lugs are connected to the collector film, particularly in a substance-bonded manner, preferably formed integrally. The electrode assembly is preferably connected via in particular the conductor lugs of the electrodes to two current-conducting devices of different polarity, particularly in a substance-bonded manner, said current-conducting devices serving to make the electrical connection of the electrode assembly to at least one electrode assembly of an adjacent energy storage cell and/or at least indirectly the electrical connection to battery terminals.

The electrodes of different polarity of the electrode assembly are preferably spaced apart by a separator, wherein the separator is conductive to ions, but not or only little to electrons. The separator preferably contains at least some of the electrolyte or of the conducting salt. The electrolyte is preferably substantially formed without a liquid fraction, particularly following closure of the energy storage cell. The conducting salt preferably comprises lithium ions. Lithium ions are particularly preferably deposited or intercalated in the negative electrode during charging and removed again during discharging.

The electrode assembly is preferably configured as a substantially prismatic electrode stack. The electrode stack comprises a predefined sequence of stacking plates in its stacking direction, wherein two electrode sheets of different polarity in each case are separated by a separator sheet. Electrode sheets of the same polarity are preferably electrically connected to one another in particular via a common current-conducting device. This configuration of the electrode assembly offers the advantage that the charging capacity of the electrode assembly, indicated in ampere-hours [Ah] or in watt-hours [Wh], less commonly in coulombs [C], for example, can easily be increased by adding further electrode sheets. Particularly preferably, at least two separator sheets are connected to one another and enclose a limiting edge of an electrode sheet. An electrode assembly of this kind, having a single, particularly meander-shaped, separator offers the advantage that a parasitic current starting from this limiting edge to an electrode sheet of different polarity is encountered.

The electrode assembly of the energy storage cell is at least partially enclosed by a film-like casing. A casing within the meaning of the invention is particularly understood to mean a device, which at least partially surrounds the energy storage cell and delimits it in respect of its environment. The film-like configuration of the casing enables it to provide an at least partially adaptive mechanical structure, in which components of the energy storage cell are located. The film-like casing is preferably multi-layered, i.e. made of two, three, four, five or more layers. The multiple layers of the casing are preferably permanently connected to one another and/or jointly produced in one production step as a unitary composite layer. The film-like casing preferably comprises an electrical insulating leayer on its inner side facing to the electrode assembly. The film-like casing preferably comprises a fluid-tight layer, preferably a metal layer, which preferably acts as a water vapour barrier. Energy storage cells comprising such film-like casings are also referred to as pouch or coffee bag cells.

The film-like casing according to the invention comprises at least one first functional layer and at least one electrical insulating layer. The casing may consist of only these functional and insulating layers within the framework of the invention, but preferably comprises still further layers or strata alongside the aforementioned layers.

In one configuration of the invention, the at least one first functional layer and/or the at least one electrical insulating layer are an integral constituent part of the casing, i.e. they form a common component together with the casing, which is disposed around the electrode assembly. In another configuration of the invention, the at least one first functional layer and the at least one electrical insulating layer are provided as a separate structural unit separate from the customary or remaining casing; they may then be connected preferably in a substance-bonded manner to the latter or fitted around the electrode assembly in a separate production step. In this configuration, the functional and insulating layers themselves may be configured in a film-like or substantially dimensionally stable manner. These functional and insulating layers in this configuration may also be disposed both within the remaining casing, both outside the remaining casing or partly within and partly outside the remaining casing.

The casing of the electrode assembly according to the invention comprises at least one, i.e. preferably one, two, three or more first functional layers and at least one, i.e. preferably one, two, three or more electrical insulating layers.

The at least one first functional layer preferably extends over the entire region of the casing, at least substantially over the entire main surfaces of the casing on both sides of the electrode assembly in the stacking direction thereof, or at least substantially over the entire main surface of the casing on one side of the electrode assembly in the stacking direction thereof. In the case of a plurality, i.e. at least two first functional layers, these preferably extend substantially congruently or at least partially overlapping one another within the casing. The at least one electrical insulating layer preferably extends over the entire area of the casing or at least substantially over the entire main surfaces of the casing on both sides of the electrode assembly in the stacking direction thereof.

The at least one first functional layer is designed to be at least partially, preferably substantially over its entire area, electrically conductive. The at least one first functional layer is designed to be at least partially, preferably substantially over its entire layer thickness electrically conductive. The at least one first functional layer is preferably formed as one piece or assembled from a plurality of segments. The at least one first functional layer is single-layered or multi-layered in design.

The at least one first functional layer of the casing is directly or indirectly connected in an electrically conductive manner to the first electrodes of the electrode assembly. The at least one first functional layer of the casing is preferably connected to all first electrodes of the electrode assembly in an electrically conductive manner.

The at least one first functional layer of the casing is separated from the electrode assembly by at least one electrical insulating layer in the layering direction of the casing. An electrical insulating layer in this context should be understood to mean a layer having such a high electrical resistance, particularly in its layer thickness direction, which can substantially prevent an electrical current flow between the first and second electrodes of the electrode assembly via the at least one first functional layer, even with a completely charged energy storage cell, and over the entire application temperature range of the energy storage cell. The necessary resistance value in this context particularly also depends on the transitional resistances between the at least one first functional layer of the casing and the first electrodes of the electrode assembly. The resistance value of the electrical insulating layer may be particularly influenced by the choice of material and the layer thickness of the insulating layer. The electrical insulating layer is single-layered or multi-layered in design.

The normal operating state of the energy storage cell, in which the at least one first functional layer of the casing is separated from the electrode assembly in the layering direction of the casing by the at least one electrical insulating layer, should be understood to mean all operating states in which charging or discharging of the energy storage cell and stable energy storage is possible without risk. The at least one electrical insulating layer separates the first functional layer(s) of the casing from the electrode assembly, at least in such a risk-free normal operating state of the electrode assembly. In certain hazardous situations, particularly during the application of pressure or the action of foreign bodies on the energy storage cell or the casing thereof, however, the electrical insulation effected by the at least one electrical insulating layer can be removed.

In a preferred configuration of the invention, the casing further comprises at least one second functional layer, which is designed to be at least partially electrically conductive and is connected in an electrically conductive manner to the at least one second electrode of the electrode assembly, and at least one further electrical insulating layer, which separates the first and second functional layers of the casing from one another in the layering direction of the casing, in the normal operating state of the energy storage cell.

With this configuration, the first and second functional layers of the casing are connected to one another in an electrically conductive manner or short-circuited in a hazardous state as described above, so that a closed current path between the electrodes of different polarity in the energy storage cell can form, across which the energy storage cell can then discharge in a controlled manner.

The above comments in relation to the at least one first functional layer of the casing apply correspondingly to this at least one second functional layer of the casing. The above comments in relation to the at least one insulating layer apply correspondingly to this at least one further insulating layer.

In another preferred configuration of the invention, the casing comprises at least one first functional layer, which is designed to be at least partially electrically conductive and is connected in an electrically conductive manner to the at least one first electrode of the electrode assembly, on the one side of the electrode assembly in a stacking direction of the electrode assembly, and at least one second functional layer, which is designed to be at least partially electrically conductive and is connected in an electrically conductive manner to the at least one second electrode of the electrode assembly, on the other side of the electrode assembly.

The first functional layer on the one side of the electrode assembly and the second functional layer on the other side of the electrode assembly are—at least in the normal operating state of the energy storage cell—preferably electrically insulated from one another. In the layering direction of the casing, at least one electrical insulating layer is preferably disposed between the at least one first functional layer and the electrode assembly and at least one electrical insulating layer is preferably disposed between the at least one second functional layer and the electrode assembly. The electrical insulating layers on both sides of the electrode assembly are preferably connected to one another or separately from one another. The at least one first functional layer on the one side of the electrode assembly is connected in an electrically conductive manner to at least one first electrode of the electrode assembly and the at least one second functional layer on the other side of the electrode assembly is connected in an electrically conductive manner to at least one second electrode of the electrode assembly, so that in this preferred configuration the first and second functional layers of the casing on different sides of the electrode assembly can function independently of one another. The first and second functional layers on the different sides of the electrode assembly are preferably each connected in an electrically conductive manner to a type of electrode in the electrode assembly which does not lie on the outside in the stacking direction of the electrode assembly.

The above comments in connection with the at least one first functional layer of the casing apply correspondingly to these first and second functional layers of the casing.

In a variation of the last described configuration, the energy storage cell according to the invention may also be equipped with a “nail safety device” on one side only. In this case, the casing comprises at least one first functional layer which is designed to be at least partially electrically conductive and is connected in an electrically conductive manner to the at least one first electrode of the electrode assembly on the one side of the electrode assembly in a stacking direction of the electrode assembly, while on the other side of the electrode assembly no functional layer which is designed to be at least partially electrically conductive and is connected to any electrode in the electrode assembly in an electrically conductive manner is provided. In the layering direction of the casing, at least one electrical insulating layer is preferably disposed between the at least one first functional layer and the electrode assembly.

In yet another preferred configuration of the invention, the electrode assembly comprises outermost electrodes in a stacking direction of the electrode assembly each formed as a second electrode, and the casing comprising at least one first functional layer, which is designed to be at least partially electrically conductive and is connected in an electrically conductive manner to the at least one first electrode of the electrode assembly on both sides of the electrode assembly in a stacking direction of the electrode assembly.

The first functional layer on the one side of the electrode assembly and the first functional layer on the other side of the electrode assembly are preferably formed integrally with one another, connected to one another in an electrically conductive manner as separate components or electrically insulated from one another as separate components. In the layering direction of the casing, at least one electrical insulating layer in each case is preferably disposed between the at least one first functional layer and the electrode assembly. The electrical insulating layers on both sides of the electrode assembly are preferably connected to one another or separately from one another.

In a preferred configuration of the invention, the first functional layer and/or the second functional layer of the casing are substantially fluid-tight in design. With this configuration, an additional fluid-tight layer in the casing can preferably be omitted. The first or second functional layer, which is fluid-tight in design, can therefore simultaneously act as a water vapour barrier. In configurations in which a functional layer is provided on only one side of the electrode assembly, an additional fluid-tight layer is preferably provided on the other side of the electrode assembly.

In a preferred configuration of the invention, the casing comprises sat least one puncture-resistant protective layer on its side of the first and/or second functional layers facing the electrode assembly. This puncture-resistant layer preferably comprises a woven or knitted fabric of reinforcing fibres, particularly aramid fibres, and/or one or a plurality of metallic inserts, which are preferably connected to one another, and/or one or a plurality of oxide-ceramic inserts, which are preferably plate-shaped in design. This configuration offers the advantage that the casing sets a greater mechanical resistance against the penetration of a foreign body into the inside of the energy storage cell.

In a further configuration of the invention, the electrical insulating layer of the casing facing the electrode assembly is at the same time configured as a puncture-resistant protective layer.

In a preferred configuration of the invention, at least one discharge resistor is connected between the first functional layer and the at least one first electrode of the electrode assembly and/or between the second functional layer and the at least one second electrode of the electrode assembly. This at least one discharge resistor is preferably disposed at least partially outside the casing and/or connected in a heat-conductive manner to a component outside the casing. The discharge resistor is particularly provided to convert electrical energy from the electrode assembly into heat energy during controlled discharging. In this configuration, a discharge current which flows from the electrode assembly in the case of short-circuited first and second functional layers can be additionally limited by the discharge resistor. In this way, the electrical heat output can also be limited. Preferably, one, two, three, four or more discharge resistors are provided for an energy storage cell.

The at least one discharge resistor preferably comprises a predetermined electrical resistance value. The total electrical resistance value is preferably at least 0.5 Ω, further preferably at least 2 Ω, further preferably at least 5 Ω, further preferably at least 10 Ω, further preferably at least 20 Ω, further preferably at least 50 Ω, further preferably at least 100 Ω, further preferably at least 200 Ω, further preferably at least 500 Ω, further preferably at most 1,000 Ω. The discharge resistor is particularly preferably adapted to the electrical voltage of the energy storage cell, such that the heat output in the discharge resistor during the controlled discharge of the energy storage cell is limited to maximum 500 W, further preferably to maximum 200 W, further preferably to maximum 100 W, further preferably to maximum 50 W, further preferably to maximum 20 W, further preferably to maximum 10 W, further preferably to maximum 2 W.

By means of the preferred arrangement and/or heat-conductive connection of the at least one discharge resistor outside the casing, it can preferably be achieved that the heat generated by the energy storage cell during controlled discharge is released to the outside and the inside of the cell with the electrode arrangement is not heated too greatly.

In yet a further preferred configuration of the invention, the at least one first functional layer and/or the at least one second functional layer of the casing are at least partially configured as metal films.

Subject-matter of the invention is also an electrochemical energy storage device, which comprises at least one electrochemical energy storage cell of the invention described above. An electrochemical energy storage device of this kind can also be referred to as a battery. The energy storage device further comprises a preferably dimensionally stable housing to accommodate the at least one energy storage cell and at least two battery terminals of different polarity, which are connected in an electrically conductive manner to the electrode assembly/assemblies of the at least one energy storage cell. In case of a plurality of energy storage cells in the battery, these are preferably connected to one another in series or in parallel via their current-conducting devices between the battery terminals.

The energy storage device according to the invention includes at least one of the energy storage cells according to the invention described above. In one configuration of the invention, the energy storage device exclusively includes energy storage cells, which are configured according to the invention. In another configuration of the invention, the energy storage device includes one or a plurality of energy storage cells configured according to the invention, and also one or a plurality of energy storage cells configured in some other way. In the latter case, the energy storage cells comprising a casing having first and possibly second functional layers according to the invention are preferably disposed outwardly in an assembly direction of the energy storage cells and thus close to a housing wall of the battery. The advantage of this is that only the outer energy storage cells, which are exposed to greater risk of action by a foreign body, must be configured with a special casing according to the invention.

In the configuration of the energy storage cell with at least one discharge resistor, said resistor is preferably connected to the housing of the battery in a heat-conductive manner.

In a preferred configuration of the invention, at least one measuring device is provided, which is configured to detect a state and/or a change of state of the electrical connection between the at least one first functional layer and the at least one second functional layer of the casing of at least one of the at least one energy storage cell. In another preferred configuration of the invention, at least one measuring device is provided, which is configured to detect a state and/or a change of state of the electrical connection between the at least one first functional layer of the casing and the least one first electrode and/or between the at least one second functional layer of the casing and the at least one second electrode of at least one of the at least one energy storage cell. Depending on the configuration of the energy storage cells or the casings thereof, a hazardous state of the battery, particularly due to the application of pressure or action by a foreign body on one or a plurality of energy storage cells, can be detected using a measuring device of this kind. The measuring device is preferably configured to detect an electrical current and/or an electrical voltage particularly of the electrode assembly of an energy storage cell.

In a further preferred configuration of the invention, at least one current interrupting device is provided, which is configured to interrupt the electrically conductive connection between at least one of the battery terminals and the electrode assembly/assemblies of the at least one energy storage cell. The current interrupting device is preferably coupled to the afore-mentioned measuring device.

The current interrupting device is particularly used to insulate the energy storage cell electrically with respect to its environment. With the help of the current interrupting device, particularly the electrical connection between one of the current-conducting devices of the energy storage cell and a battery terminal particularly of the same polarity can be interrupted at least temporarily. The current interrupting device is particularly provided to be activated and in the activated state to interrupt the electrical connection between the current-conducting device and the battery terminal particularly of the same polarity. The current interrupting device preferably has a controlled switch, preferably a semiconductor switch or a relay. The current interrupting device is preferably controlled by a battery control device or a battery management system. The controlled switch of the current interrupting device can preferably be closed again after a particular predetermined period of time. This preferred configuration offers the advantage that after closing the switch the electrical voltage of the energy storage cells can be measured across the battery terminals. In another preferred configuration, the current interrupting device comprises a disconnecting device which is particularly controlled by the battery control device, and an electrical conductor. The electrical conductor is connected between the current-conducting device of the energy storage cell and the battery terminal. The disconnecting device is provided to act on the electrical conductor, such that the electrical conductivity thereof is largely, particularly substantially completely lost. The disconnecting device is preferably configured to divide the electrical conductor, such that the current path between the current-conducting device and the battery terminal is interrupted. This preferred configuration offers the advantage of greater battery safety, particularly also following the harmful effects of a foreign body.

In a preferred configuration of the invention, the battery comprises a display device. The display device is provided to display particularly the hazardous state of the energy storage cell in relation to the functional layers of its casing and/or to transmit corresponding information, particularly to a battery control or an independent control. This configuration offers the advantage that information on the state of the battery or of the energy storage cell(s) can be made available to an individual. The display device is particularly preferably configured as a beeper, light-emitting diode, infrared interface, GPS device, GSM assembly, first near-field device or transponder.

Further advantages, features and applications of the present invention result from the following description in conjunction with the figures. In the figures:

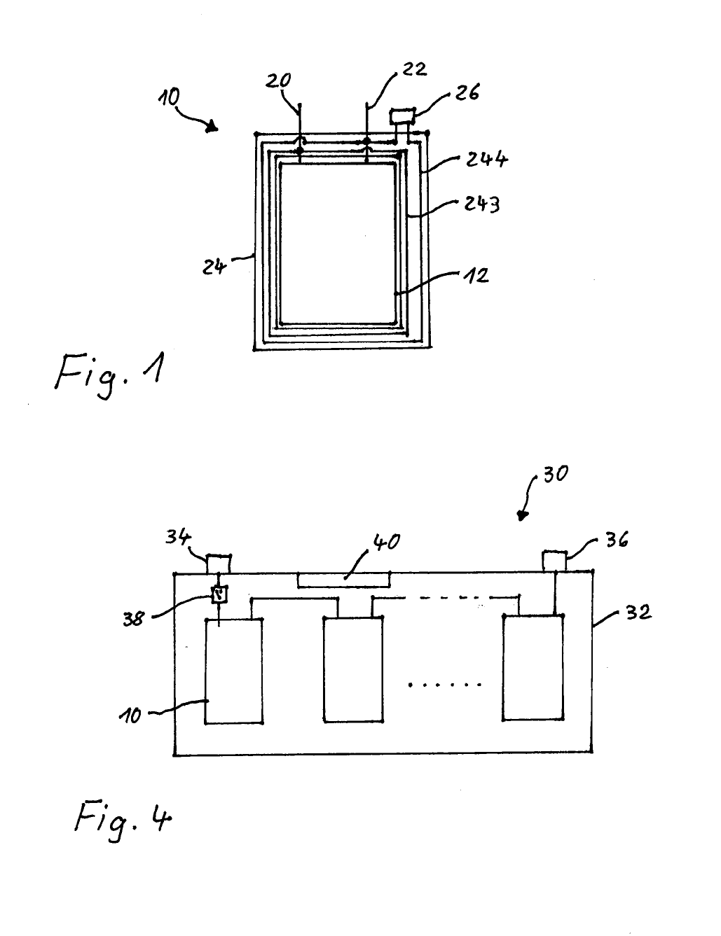

FIG. 1 shows a schematic representation of the structure of an electrochemical energy storage cell according to a preferred exemplary embodiment of the present invention;

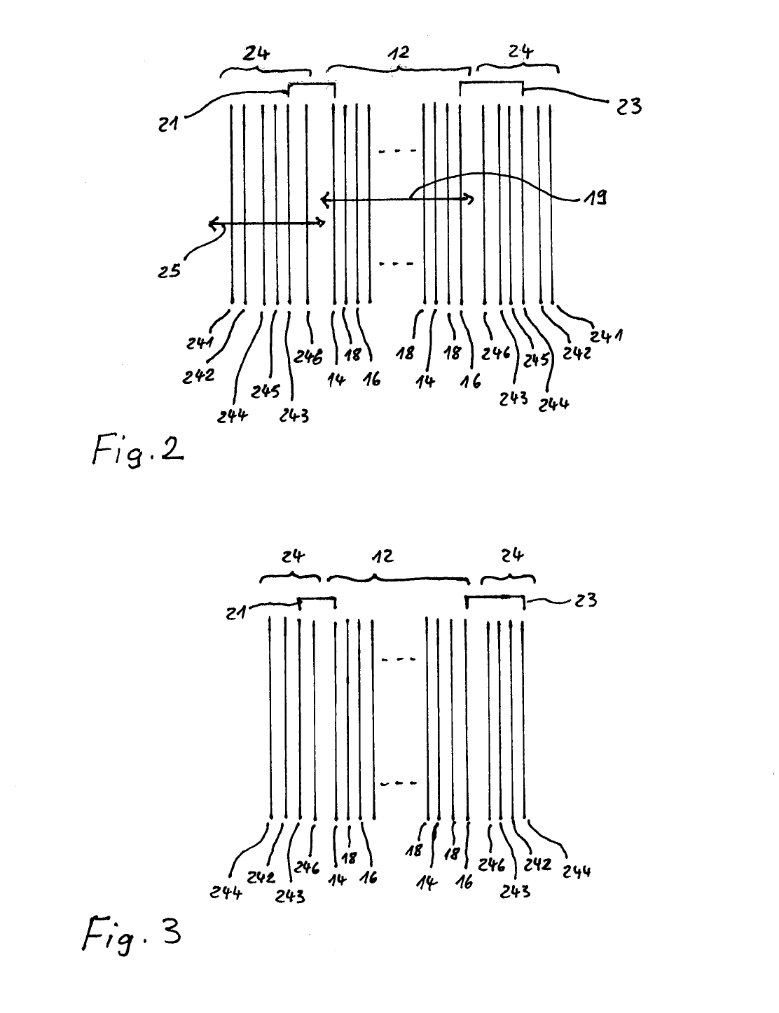

FIG. 2 shows a schematic representation of the layer structure of a casing of the energy storage cell in FIG. 1 according to a first exemplary embodiment;

FIG. 3 shows a schematic representation of the layer structure of a casing of the energy storage cell in FIG. 1 according to a second exemplary embodiment;

FIG. 4 shows a schematic representation of the structure of an electrochemical energy storage device or battery with a plurality of energy storage cells according to a preferred exemplary embodiment of the present invention;

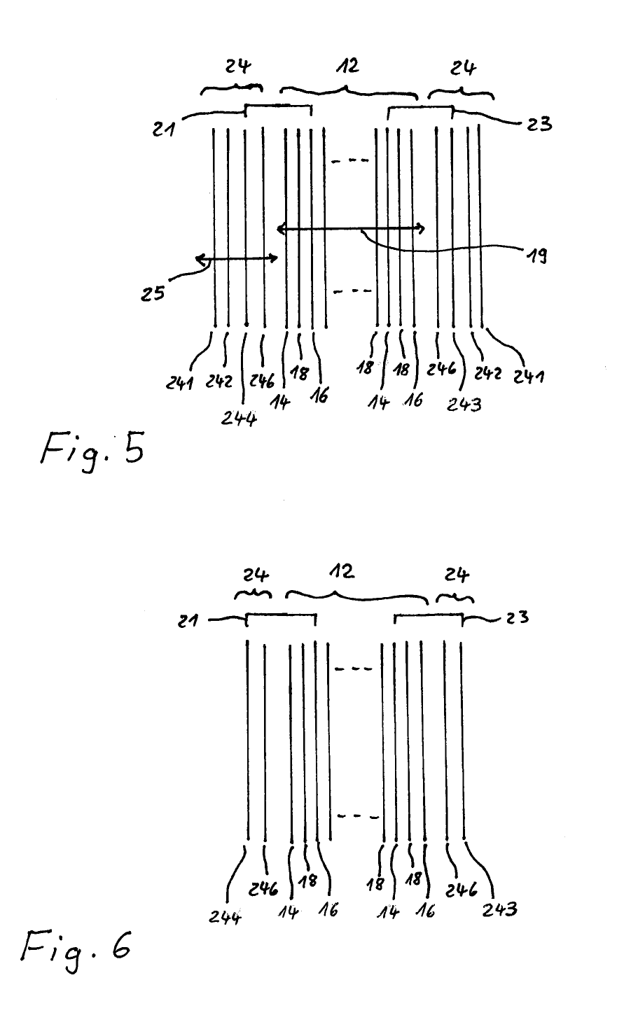

FIG. 5 shows a schematic representation of the layer structure of a casing of an energy storage cell according to a further exemplary embodiment;

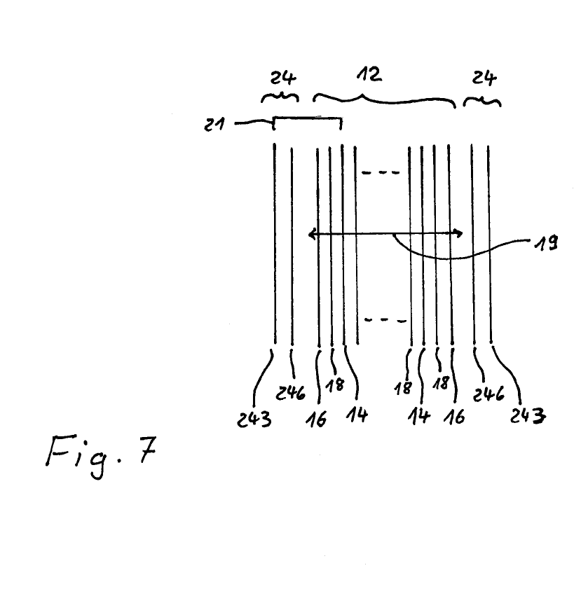

FIG. 6 shows a schematic representation of the layer structure of a casing of an energy storage cell according to yet a further exemplary embodiment; and

FIG. 7 shows a schematic representation of the layer structure of a casing of an energy storage cell according to yet a further exemplary embodiment.

FIG. 1 shows schematically the structure of a rechargeable electrochemical energy storage cell 10 in the form of a pouch cell according to the invention. The energy storage cell 10 includes an electrode assembly 12, which is substantially completely enclosed by a film-like casing 24.

As illustrated in FIGS. 2 and 3, the electrode assembly 12 comprises a substantially prismatic electrode stack made up of first electrodes 14 and second electrodes 16 of different polarity. The first and second electrodes 14, 16 are separated from one another by a separator 18.

The conductor lugs (not shown) of the first electrodes 14 are connected to a first current-conducting device (current conductor) 20 in an electrically conductive manner. The conductor lugs (not shown) of the second electrodes 16 are connected to a second current-conducting device (current conductor) 22 in an electrically conductive manner. Both current-conducting devices 20, 22 are led to the outside through the casing 24. The casing 24 is sealed in a fluid-tight manner in the region of these conductor bushings.

Back to FIG. 1, a first functional layer 243 and a second functional layer 244 are indicated in the casing 24 of the electrode assembly 12. The second functional layer 244 is connected to the second current-conducting device 22 in an electrically conductive manner via a discharge resistor 26; the first functional layer 243, on the other hand, is directly connected to the first current-conducting device 20 in an electrically conductive manner. The first and the second functional layers 243, 244 are each configured as electrically conductive metal films. Moreover, the first and second function layers 243, 244 are electrically insulated from one another in the layering direction 25 of the casing 24.

Although not shown, alternatively or additionally, the first functional layer 243 of the casing 24 may also be connected to the first current-conducting device 20 via a discharge resistor 26. It is likewise possible to provide a plurality of discharge resistors 26. Furthermore, the at least one discharge resistor 26 of the energy storage cell 10 may also be connected in a heat-conducting manner to an external component, for example a battery housing, in order to release outwardly the heat generated during the controlled discharge of the electrode assembly 12.

If a foreign body, for example a metal needle, strikes this energy storage cell 10, this needle may penetrate the casing 24. As soon as the electrically conductive needle makes contact with or pierces the innermost of the two functional layers of the casing 24, the two functional layers 243, 244 are connected to one another by the needle in an electrically conductive manner and thus the first electrodes 14 and the second electrodes 16 of the electrode assembly 12 are short-circuited. The electrode assembly 12 can therefore be discharged in a controlled fashion via the functional layers 243, 244 of the casing 24 and the discharge resistor 26.

The controlled discharge of the electrode assembly 12 can also take place during the application of pressure from outside on the energy storage cell 10. If the pressure exceeds a given level, the casing 24 may deform in such a way that the first functional layer 243 and the second functional layer 244 come into contact with one another. This may occur particularly in the case of pressure forces applied to the energy storage cell 10 in an uneven, particularly substantially pointwise, manner. The same applies to the penetration of a foreign body made of a material which is not or barely electrically conductive.

By virtue of the discharge resistor 26 provided in the current path of the electrodes 14, 16 and functional layers 243, 244, electrical energy is converted into heat output. The discharge resistor 26 is preferably disposed at least partially outside the casing 24, so that this heat can be delivered outwardly from the energy storage cell 10 and the inside of the energy storage cell 10 is not heated up. The heat occurring during discharge and the period of time involved in the discharging process can be adjusted via the resistance value of the discharge resistor 26.

A first exemplary embodiment of the layer structure of a casing 24 of the energy storage cell 10 according to the invention in FIG. 1 is illustrated in FIG. 2.

In this exemplary embodiment the casing 24 includes an outer, substantially fluid-tight layer 241 and an electrical insulating layer 242 on the side of the fluid-tight layer 241 facing the electrode assembly 12. This layer structure 241, 242 substantially corresponds to the structure of conventional film-like casings for pouch cells.

In addition to these two layers 241, 242, the first functional layer 243 and the second functional layer 244 are provided on the side of the layers 241, 242 facing the electrode assembly 122. An electrical insulating layer 245 is disposed between the two functional layers 243, 244.

On the inside of the first functional layer 243 facing the electrode assembly 12 an electrical insulating layer 246 is likewise provided. This insulating layer 246 should guarantee electrical insulation between the electrode assembly 12 and the casing 24—at least in the normal operating state of the energy storage cell 10.

In a special variant of this exemplary embodiment, this inner insulating layer 246 is simultaneously configured as a puncture-resistant protective layer. This is achieved, for example, by means of integrated woven fabric, knitted fabric, metal plates or the like. A foreign body should thereby be prevented from completely penetrating the casing 24 and penetrating the electrode assembly 12 of the energy storage cell 10.

The “normal” layers 241-242 of the casing 24 and the “nail safety device” layers 243-246 of the casing 24 are configured as a combined composite layer, for example.

In another embodiment, the “normal” layers 241-242 of the casing 24 and the “nail safety device” layers 243-246 of the casing 24 are configured as separate components, which are laid around the electrode assembly 12 one after the other or are jointly laid together around the electrode assembly 12 following a preferably substance-bonded connection. In this case, the “nail safety device” layers 243-246 of the casing 24 themselves may be configured in a film-like or substantially dimensionally stable manner. Moreover, the “nail safety device” layers 243-24 of the casing 24 are provided either on both main sides of the electrode assembly 12 or on only one main side of the electrode assembly 12, selectively.

A second exemplary embodiment of the layer structure of a casing 24 of the energy storage cell 10 according to the invention in FIG. 1 is illustrated in FIG. 3.

In this exemplary embodiment, the “nail safety device” layers provided according to the invention are integrated into the “normal” casing layers. In particular, the second functional layer 244 simultaneously forms the fluid-tight layer. The electrical insulating layer 242 forms the electrical insulation between the first and the second functional layer 243, 244.

On the inside of the first functional layer 243 facing the electrode assembly 12, an electrical insulating layer 246 is also provided in this exemplary embodiment, which can optionally be configured at the same time as a puncture-resistant protective layer.

The exemplary embodiment in FIG. 3 provides a particularly compact, multi-functional layer structure of the casing 24.

In FIGS. 2 and 3, the electrically conductive connection between the first functional layer 243 of the casing and the first electrodes 14 of the electrode assembly 12 is indicated by a first connection 21, and the electrically conductive connection between the second functional layer 244 of the casing 24 and the second electrodes 16 of the electrode assembly 12 is indicated by a second connection 23. A representation of the at least one discharge resistor 26 has been omitted in FIGS. 2 and 3.

Even if the layers of the casing 24 and of the electrode assembly 12 in FIGS. 2 and 3 are each represented with spaces in between, the energy storage cell 10 is preferably configured without these spaces. In particular, the casing 24 is preferably formed from a uniform composite layer 241-246 and the electrode assembly 12 is preferably configured without hollow spaces and the electrode assembly 12 preferably encloses the casing 24 without the inclusion of hollow spaces. In addition, the layers 241-246 of the casing 24 are each single-layered or multi-layered in design.

Even if in FIGS. 2 and 3 the casing 24 is represented substantially identically on both main sides in the stacking direction 19 of the electrode assembly 12, the casing 24 need not necessarily have an identical structure on both main sides of the electrode assembly 12. For example, the first and second functional layers 243, 244 may also be present in the casing 24 only on one main side of the electrode assembly 12.

FIG. 4 shows schematically the structure of an electrochemical energy storage device or battery 30 according to the present invention.

The battery 30 has a preferably dimensionally stable housing 32. Accommodated in this housing 32 is a plurality of energy storage cells 10 enabling the desired battery capacity to be set. As indicated in FIG. 4, the electrode assemblies 12 of the energy storage cells 10 are connected in series between two battery terminals 34 and 36 via their current-conducting devices 20, 22 projecting from the casing 24. Alternatively, the energy storage cells 10 may also be connected in parallel to one another or in a combined parallel and series connection.

The discharge resistors 26 of the energy storage cells 10 may, for example, be connected to the housing 32 of the battery in a heat-conductive manner. In this way, the heat generated during the controlled discharge of an energy storage cell 10 can be conducted outwards via the battery housing 32.

As shown in FIG. 4, the housing 32 contains a plurality of electrochemical energy storage cells 10, which are disposed alongside one another. In one embodiment the battery 30 contains only energy storage cells 10, which comprise a casing 24 with first and second functional layers 243, 244 according to the exemplary embodiments in FIG. 2 or 3.

In another embodiment, the battery 30 also contains apart from one or a plurality of energy storage cells 10 according to the invention, one or a plurality of differently configured energy storage cells, for example conventional energy storage cells without a “nail safety device”. In this embodiment, the energy storage cells 10 according to the invention are preferably disposed in the assembly direction of the energy storage cells (right/left direction in FIG. 4) on the outside and therefore close to the housing 32 of the battery 30. The risk of action by a foreign body exists particularly on these outer energy storage cells, which is why it is sufficient for only these to be equipped with a corresponding protective mechanism according to the invention.

As illustrated in FIG. 4, a current interrupting device 38 is assigned to a battery terminal 34. Moreover, a measuring device 40 is provided in the battery housing 32.

The measuring device 40 may comprise one or a plurality of measuring means being able to detect a state and/or a change of state of the electrical connection between the at least one first functional layer 243 and the at least one second functional layer 244 of the casing 24 of at least one of the energy storage cells 10. The measuring means of the measuring device 40 are configured, for example, to detect an electrical current and/or an electrical voltage particularly of the electrode assembly 12 of an energy storage cell 10, in order to infer from this the electrical resistance between the first and second functional layers 243, 244 of the casing 24.

Using this measuring device 40, a hazardous state of the battery 30, particularly due to the application of pressure or the action of a foreign body on one or a plurality of energy storage cells 10, can be detected.

The measuring device 40 is preferably connected to a battery control device or to a battery management system. Moreover, the measuring device 40 is preferably connected to the current interrupting device 38.

The current interrupting device 38 is configured to interrupt the electrically conductive connection between the battery terminal 34 and the energy storage cells 10 when a hazardous state is detected by the measuring device 40, i.e. to disconnect the battery terminal 34 within the housing 32. In this way, the battery 30 can be reliably prevented from continuing to deliver electrical energy to a connected consumer in a hazardous state.

The current interrupting device 38 comprises, for example, a controlled switch, for example a semiconductor switch, or a relay. This controlled switch of the current interrupting device 38 can preferably be closed again after a predetermined period of time, so that after closing the switch, the electrical voltage of the energy storage cells 10 can be measured across the battery terminals 34, 36. The afore-mentioned period of time is measured in this case, such that the electrode assemblies 12 of the energy storage cells 10 at risk from a foreign body or from pressure can discharge at least for the most part via the functional layers 243, 244 of the casing 24 and the associated discharge resistors 26.

Although not shown, the battery 30 may also comprise a display device. This display device is provided to display the hazardous state of the energy storage cells 10 detected by the measuring device 40 and/or to transmit corresponding information, particularly to a battery control or an independent control. With the help of the display device, information on the state of the battery 30 or of the energy storage cell(s) 10 can be made available to an individual.

FIG. 5 shows schematically the layer structure of the casing 24 of the energy storage cell 10 according to a third exemplary embodiment.

This exemplary embodiment is distinguished from the exemplary embodiment shown in FIG. 2 principally in that only one functional layer is provided in the casing 24 on either side of the electrode assembly 12 in the stacking direction 19 of the electrode assembly 12 (right/left direction in FIG. 5).

On the one side of the electrode assembly 12 (on the left in FIG. 5) the casing 24 only comprises (at least) one second functional layer 244 alongside the fluid-tight layer 241 and the electrical insulating layer 242, said functional layer being connected in an electrically conductive manner to the second electrode 16 of the electrode assembly 12. Between this second functional layer 244 and the electrode assembly 12 an electrical insulating layer 246 is provided in the layering direction 25 of the casing 24 (right/left direction in FIG. 5). On the other side of the electrode assembly 12 (on the right in FIG. 5) the casing 24 only comprises (at least) one first functional layer 243 alongside the fluid-tight layer 241 and the electrical insulating layer 242, said functional layer being connected to the first electrodes 14 of the electrode assembly 12 in an electrically conductive manner. Between this first functional layer 243 and the electrode assembly 12 an electrical insulating layer 246 is provided in the layering direction 25 of the casing 24 (right/left direction in FIG. 5). The electrical insulating layers 246 on both sides of the electrode assembly 12 are preferably configured as a continuous, unitary insulating layer.

As represented in FIG. 5, the one functional layer 243 or 244 of the casing 24 is connected to the electrode 14 or 16 of the electrode assembly 12 in an electrically conductive manner on its side of the electrode assembly 12 which is not outermost in the stacking direction 25 of the electrode assembly 12. This produces the following method of operation of the “nail safety device” casing.

If a foreign body, for example a metal needle, encounters this energy storage cell 10, said needle may pierce the casing 24. As soon as the electrically conductive needle comes into contact with the electrode assembly 12, i.e. the outermost electrode thereof, the functional layer 243, 244 of the casing 24 in each case is connected by the needle to this outer electrode 16, 14 in an electrically conductive manner and the first electrodes 14 and the second electrodes 16 of the electrode assembly 12 are thereby short-circuited. The electrode assembly 12 can therefore be discharged in a controlled manner via the functional layer 243, 244 of the casing 24 and the discharge resistor 26.

A corresponding method of operation also applies during the application of pressure from outside to the energy storage cell 10 and to the penetration of a foreign body made of a material which is not or barely electrically conductive.

Otherwise, the structure of the energy storage cell in FIG. 5 corresponds to the first exemplary embodiment in FIG. 2. The energy storage cell in FIG. 5 can also be used correspondingly in a battery according to FIG. 4.

FIG. 6 shows schematically the layer structure of a casing 24 of the energy storage cell 10 according to a fourth exemplary embodiment.

This exemplary embodiment is based on a combination of the third exemplary embodiment in FIG. 5 and the second exemplary embodiment in FIG. 3. In particular, the casing 24 includes only one functional layer 243 or 244 on either side of the electrode assembly 12 in the stacking direction 25 of the electrode assembly 12 and this (at least) one functional layer 243, 244 is compactly integrated into the casing 24.

In a variant according to the invention in FIGS. 5 and 6, the casings 24 of the energy storage cells 10 may also each be provided with an electrically conductive functional layer 243, 244 on only one main side of the electrode assembly 12 (i.e. only on the right or left in the figures).

Otherwise, the structure of the energy storage cell in FIG. 6 corresponds to the second exemplary embodiment in FIG. 3. The energy storage cell in FIG. 6 can also be used in a corresponding manner in a battery according to FIG. 4.

FIG. 7 shows schematically the structure of an energy storage cell 10 according to a fifth exemplary embodiment.

This exemplary embodiment differs from the exemplary embodiment shown in FIG. 6 primarily in that a second electrode (i.e. electrode of second polarity) 16 in each case is disposed as the outermost electrode of the assembly 12 in the stacking direction 19 of the electrode assembly 12 (right/left direction in FIG. 7) and the casing 24 on both sides of the electrode assembly 12 includes at least one first functional layer 243 as well as the electrical insulating layer 246. This first functional layer 243 and also the electrical insulating layer 246 may extend continuously over the entire casing 24 in this case. The structure of the casing 24 may be further simplified in this way.

In order to short-circuit the first and second electrodes 14, 16 of the electrode assembly 12 in a hazardous state (penetration of a foreign body, application of pressure), the first functional layer 243 of the casing 24 is connected to the first electrodes (i.e. electrodes of first polarity) 14 in an electrically conductive manner in each case, while in the stacking direction 19 of the electrode assembly 12 second electrodes 16 lie on the outside in each case.

Otherwise, the structure of the energy storage cell in FIG. 7 corresponds to the exemplary embodiments in FIGS. 3 and 6. The energy storage cell in FIG. 7 can also be used in a corresponding manner in a battery according to FIG. 4.

Moreover, the exemplary embodiments described above may be combined with one another in any manner, in order to obtain further embodiments according to the present invention.

### LIST OF REFERENCE NUMBERS

10 Energy storage cell
12 Electrode assembly
14 First electrodes
16 Second electrodes

### 18 Separator

19 Stacking direction of 12
20 First current-conducting device
21 First connection
22 Second current-conducting device
23 Second connection

### 24 Casing

241 Fluid-tight layer
242 Electrical insulating layer
243 First functional layer
244 Second functional layer
245 Further electrical insulating layer
246 Electrical insulating layer and/or puncture-resistant protective layer
25 Layering direction of 24
26 Discharge resistance
30 Energy storage device or battery

### 32 Housing

34 First battery terminal
36 Second battery terminal
38 Current interrupting device
Measuring device

1. An electrochemical energy storage cell comprising:
an electrode assembly comprising at least one first electrode of a first polarity and at least one second electrode of a second polarity; and
a film casing, which at least partially encloses the electrode assembly;
wherein the casing comprises at least one first functional layer, which is designed to be at least partially electrically conductive and is connected in an electrically conductive manner to the at least one first electrode of the electrode assembly, and at least one electrical insulating layer, which separates the first functional layer from the electrode assembly in a layering direction of the casing in the normal operating state of the energy storage cell.

2. The energy storage cell according to claim 1, wherein
the casing further comprises at least one second functional layer, which is designed to be at least partially electrically conductive and is connected in an electrically conductive manner to the at least one second electrode of the electrode assembly, and at least one further electrical insulating layer, which separates the first and second functional layers of the casing (24) from one another in the layering direction of the casing in the normal operating state of the energy storage cell.

3. The energy storage cell according to claim 1, wherein
the casing comprises on the one side of the electrode assembly in a stacking direction of the electrode assembly at least one first functional layer, which is to be at least partially electrically conductive and is connected in an electrically conductive manner to the at least one first electrode of the electrode assembly, and on the other side of the electrode assembly at least one second functional layer, which is designed to be at least partially electrically conductive and is connected in an electrically conductive manner to the at least one second electrode of the electrode assembly.

4. The energy storage cell according to claim 1, wherein
the electrode assembly comprises outermost electrodes in a stacking direction of the electrode assembly each formed as a second electrode; and
the casing comprises at least one first functional layer in a stacking direction of the electrode assembly on both sides of the electrode assembly, which is designed to be at least partially electrically conductive and is connected in an electrically conductive manner to the at least one first electrode of the electrode assembly.

5. The energy storage cell according to claim 1, wherein
at least one of the first functional layer and the second functional layer of the casing are formed to be substantially fluid-tight.

6. The energy storage cell according to claim 1, wherein
the casing comprises at least one puncture-resistant protective layer on a side of at least one of the first and second functional layers facing the electrode assembly in the layering direction of the casing.

7. The energy storage cell according to claim 1, wherein
at least one discharge resistor is connected between the first functional layer and the at least one first electrode of the electrode assembly or between the second functional layer and the at least one second electrode of the electrode assembly.

8. The energy storage cell according to claim 7, wherein
the at least one discharge resistor is disposed at least partially outside the casing or connected in a heat-conductive manner to a component outside the casing.

9. The energy storage cell according to claim 1, wherein
the at least one first functional layer or the at least one second functional layer of the casing are at least partially configured as metal films.

10. An electrochemical energy storage device comprising:
at least one electrochemical energy storage cell, wherein at least one of the energy storage cells is configured according to claim 1;
a housing to accommodate the at least one energy storage cell; and
at least two battery terminals of different polarity, which are connected in an electrically conductive manner to the electrode assembly or the electrode assemblies of the at least one energy storage cell.

11. The energy storage device according to claim 10, wherein
at least one measuring device is provided, which is configured to detect a state or a change of state of the electrical connection between the at least one first functional layer and the at least one second functional layer of the casing of at least one of the at least one energy storage cell.

12. The energy storage device according to claim 10, wherein
at least one measuring device is provided, which is configured to detect a state or a change of state of the electrical connection between the at least one first functional layer of the casing and the at least one first electrode or and/or between the at least one second functional layer of the casing and the at least one second electrode of at least one of the at least one energy storage cell.

13. The energy storage device according to claim 10, wherein
at least one current interrupting device is provided, which is configured to selectively interrupt the electrically conductive connection between at least one of the battery terminals and the electrode assembly of the at least one energy storage cell.

14. The energy storage device according to claim 10, further comprising:
a display device configured to display a hazardous state of at least one of the at least one of the at least one energy storage cell in relation to the functional layers of a casing thereof or to transmit corresponding information to a control device.
